(19) United States
(12) Patent Application Publication
(10) Pub. No.: US 2012/0150889 A1
(43) Pub. Date: Jun. 14, 2012

(54) METHOD AND APPARATUS TO DISPLAY DLNA DEVICES

(75) Inventor: Jong-yun CHOI, Suwon-si (KR)

(73) Assignee: Samsung Electronics Co., Ltd., Suwon-si (KR)

(21) Appl. No.: 13/307,328

(22) Filed: Nov. 30, 2011

(30) Foreign Application Priority Data
Dec. 14, 2010 (KR) 2010-0127351

(51) Int. Cl. G06F 17/30

(52) U.S. Cl. 707/758; 707/E17.032; 707/E17.01

(57) ABSTRACT

A method and apparatus to display at least one device connected through a DLNA way in a DLNA device including searching device information of one or more peripheral apparatuses, extracting URLs of media files corresponding to the one or more peripheral apparatuses respectively from the searched device information, and if there is a URL of a media file corresponding to a respective peripheral apparatus, receiving the media file corresponding to the respective peripheral apparatus from the URL, and displaying a UI to access the media files corresponding to the one or more peripheral apparatuses along with model names of the one or more peripheral apparatuses.

### CROSS-REFERENCE TO RELATED APPLICATIONS

This application claims the benefit of priority under 35 U.S.C. §119 to Korean Patent Application No. 2010-0127351, filed in the Korean Intellectual Property Office on Dec. 14, 2010, the disclosure of which is incorporated herein by reference in its entirety.

### BACKGROUND OF THE INVENTION

1. Field of the Invention

The present general inventive concept generally relates to a method and an apparatus to display a Digital Living Network Alliance (DLNA) device, and more particularly, to a method and an apparatus to display a DLNA device which is searched when a plurality of DLNA devices are searched.

2. Description of the Related Art

The DLNA represents a new official organization which will lead commercialization of an international home network, and aims at realizing convergence between industries by building an interoperable platform based on industrial standards which have already been in place. Accordingly, it is expected that manufacturers of home appliances, personal computers, and wireless devices will introduce a guideline based on widely-used industrial standards such as IP, HTTP, UPnP, and Wi-Fi, and thus, DLNA devices which have been designed following a DLNA guideline may share media contents such as music, photo, and video freely through a home network.

Meanwhile, if a DLNA device is searched, the name of the searched device is displayed and the name is obtained through a step of discovery which is a protocol designated by a DNLA standard.

However, if there are a plurality of searched DLNA devices, it is difficult for a user to identify the devices since only the names of the devices are displayed, as illustrated in FIG. 1. For example, FIG. 1 illustrates a list including the devices “SPH6000”, “HomeTv”, “ST1000”, and “Chelsy”, but it is difficult to identify which devices these are by their names alone. It is especially difficult for a user to identify the devices if the user does not set special names for the plurality of searched devices in advance.

### SUMMARY OF THE INVENTION

The present general inventive concept provides a method and an apparatus to display a DLNA device which allows a user to identify a desired DLNA device fast.

The present general inventive concept also provides a method and an apparatus to display a plurality of DLNA devices which allows a user to identify a desired DLNA device quickly.

Additional aspects and advantages of the present general inventive concept will be set forth in part in the description which follows and, in part, will be obvious from the description, or may be learned by practice of the general inventive concept.

The foregoing and/or other features and utilities of the present general inventive concept may be realized by a method of displaying at least one device connected through a DLNA way in a DLNA device, the method including searching device information of one or more peripheral apparatuses, extracting URLs of media files corresponding to the one or more peripheral apparatuses respectively from the searched device information, and if there is a URL of a media file corresponding to a respective peripheral apparatus, receiving the media file corresponding to the respective peripheral apparatus from the URL, and displaying a UI to access the media files corresponding to the one or more peripheral apparatuses along with model names of the one or more peripheral apparatuses.

The method may include, if there is no URL of the media file corresponding to the respective peripheral apparatus, transmitting the model name of the respective peripheral apparatus to a specified web server, and receiving a media file corresponding to the model name of the respective peripheral apparatus from the specified web server.

The method may include, if the media file corresponding to the respective peripheral apparatus is not included in the searched device information, transmitting the model name of the respective peripheral apparatus to a specified web server, and receiving a media file corresponding to the model name of the respective peripheral apparatus from the specified web server.

The device information may be a device description XML file.

The media file corresponding to the respective peripheral apparatus may include at least one of an image file, a video file, and an audio file corresponding to the respective peripheral apparatus.

The video file and the audio file may be files including a detailed description on how to use the respective peripheral apparatus.

The searching device information of the one or more peripheral apparatuses may include searching device information of the one or more peripheral apparatuses using a UPnP SSDP protocol.

The receiving the media file corresponding to the respective peripheral apparatus may include receiving the media file using a HTTP protocol.

The method may further include storing the received media file.

The foregoing and/or other features and utilities of the present general inventive concept may also be realized by a DLNA device display apparatus to display at least one device connected through a DLNA way, the apparatus including a device information search unit to search device information of one or more peripheral apparatuses, a device information extracting unit to extract URLs of media files corresponding to the one or more peripheral apparatuses and model names of the one or more peripheral apparatuses respectively, a media file receiving unit which, if there is a URL of a media file corresponding to a respective peripheral apparatus, receives the media file corresponding to the respective peripheral apparatus from the URL, and a display unit to display a UI to access the media file along with model names of the one or more peripheral apparatuses.

The apparatus may further include a model name transmitting unit which, if there is no URL of the media file corresponding to the respective peripheral apparatus, transmits the model name of the respective peripheral apparatuses to a specified web server, and the media file receiving unit may receive a media file corresponding to the model name of the respective peripheral apparatus from the specified web server.

The model name transmitting unit may transmit the model name of the respective peripheral apparatus to a specified web server if the media file corresponding to the respective peripheral apparatus is not included in the searched device information, and the media file receiving unit may receive a media file corresponding to the model name of the respective peripheral apparatus from the specified web server.

The device information may be a device description XML file.

The media file may include at least one of an image file, a video file, and an audio file corresponding to the respective peripheral apparatus.

The video file and the audio file may be files including a detailed description on how to use the respective peripheral apparatus.

The device information search unit may search device information of the one or more peripheral apparatuses using an UPnP SSDP protocol.

The media file receiving unit may receive the media file corresponding to the respective peripheral apparatus using an HTTP protocol.

The apparatus may further include a storage unit to store the received media file.

The foregoing and/or other features and utilities of the present general inventive concept may also be realized by a DLNA device display apparatus including a device information receiving unit to receive device information from a peripheral apparatus, the device information including a model name of the peripheral apparatus, a device information extracting unit to determine if the device information includes a URL of a media file corresponding to the peripheral apparatus, and a communication unit to retrieve the media file corresponding to the peripheral apparatus from the URL if the device information includes the URL and to transmit the model name to a web server and receives a media file corresponding to the model name of the peripheral apparatus if the device information does not include the URL.

The DLNA device display apparatus may include a display unit to display a user interface including the model name of the peripheral apparatus, an image representing the peripheral apparatus included in the media file, and one or more menu items to access at least one of video information and audio information included in the media file.

The device information extracting unit may extract at least one of the model name and the URL of the media file from the device information.

The peripheral apparatus may be a DLNA compliant device.

The media file may include at least one of an image file, a video file, and an audio file corresponding to the peripheral apparatus.

The foregoing and/or other features and utilities of the present general inventive concept may also be realized by a method of an DLNA device display apparatus connected to a peripheral apparatus, the method including receiving device information from the peripheral apparatus, the device information including a model name of the peripheral apparatus, determining if the device information includes a URL of a media file corresponding to the peripheral apparatus, retrieving the media file corresponding to the peripheral apparatus from the URL if the device information includes the URL, and transmitting the model name to a web server and receiving a media file corresponding to the model name of the peripheral apparatus from the web server if the device information does not include the URL.

The method may include displaying a user interface including the model name of the peripheral apparatus, an image representing the peripheral apparatus included in the media file, and one or more menu items to access at least one of video information and audio information included in the media file.

The foregoing and/or other features and utilities of the present general inventive concept may also be realized by a non-transitory computer-readable recording medium having embodied thereon a computer program to execute a method, wherein the method includes receiving device information from a peripheral apparatus, the device information including a model name of the peripheral apparatus, determining if the device information includes a URL of a media file corresponding to the peripheral apparatus, retrieving the media file corresponding to the peripheral apparatus from the URL if the device information includes the URL, and transmitting the model name to a web server and receiving a media file corresponding to the model name of the peripheral apparatus from the web server if the device information does not include the URL.

The method further include displaying a user interface including the model name of the peripheral apparatus, an image representing the peripheral apparatus included in the media file, and one or more menu items to access at least one of video information and audio information included in the media file.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating an example of a list UI displaying searched devices;

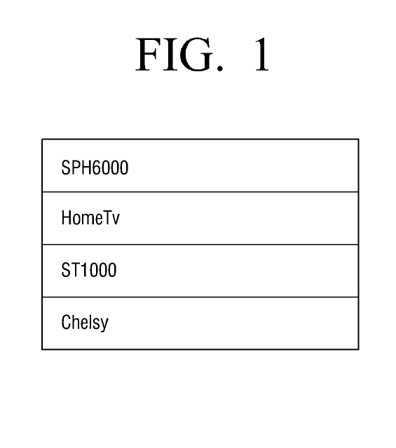

FIG. 2 illustrates a DLNA device display apparatus according to an exemplary embodiment of the present general inventive concept.

FIG. 3 illustrates a DLNA device display apparatus according to an exemplary embodiment of the present general inventive concept;

FIG. 4 is a view illustrating an example of a device description XML file as device information of a DLNA device display apparatus according to an exemplary embodiment of the present general inventive concept;

FIG. 5 is a view illustrating an example of an image of a searched device in a DLNA device display apparatus according to an exemplary embodiment of the present general inventive concept;

FIG. 6 is a view illustrating an example of a list UI displaying searched devices in a DLNA device display apparatus according to an exemplary embodiment of the present general inventive concept;

FIG. 7 is a flowchart illustrating a method to display a DLNA device according to an exemplary embodiment of the present general inventive concept; and

FIG. 8 illustrates a DLNA device display apparatus according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

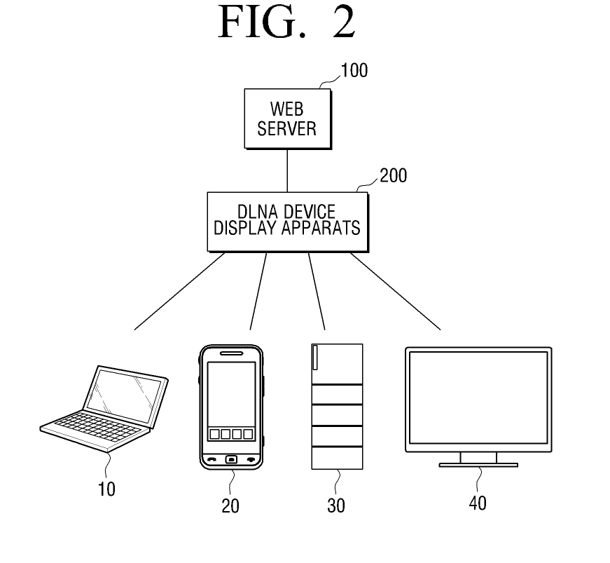

FIG. 2 illustrates a DLNA device display apparatus 200 connected to various peripheral apparatuses including a notebook computer 10, a mobile phone 20, a desktop computer 30, and a television 40. The DLNA device display apparatus 200 is also connected to a web server 100.

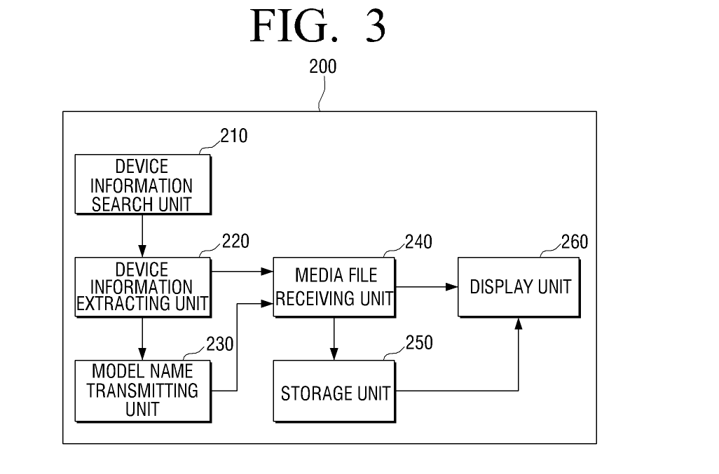

FIG. 3 is a schematic block diagram illustrating a DLNA device display apparatus 200 according to an exemplary embodiment of the present general inventive concept. As illustrated in FIG. 3, the DLNA device display apparatus 200 comprises a device information search unit 210, a device information extracting unit 220, a model name transmitting unit 230, a media file receiving unit 240, a storage unit 250, and a display unit 260.

The DLNA device display apparatus 200 may display one or more peripheral apparatuses connected to the DLNA device display apparatus 200. For instance, when the connected peripheral apparatuses are DLNA devices, the DLNA device display apparatus 200 may display the DLNA devices by displaying a user interface (UI) image to represent the connected DLNA devices. The UI image may include information such as a model name of the DLNA device, an image representing the DLNA device, and menu items to access video and audio information about the DLNA device. Components of the DLNA device display apparatus 200 are described in more detail below.

The device information search unit 210 searches device information of peripheral apparatuses.

The device information of peripheral apparatuses may be a device description XML file.

Meanwhile, the device information search unit 210 may search device information of peripheral apparatuses using a UPnP Simple Service Discovery Protocol (SSDP).

The device description XML file is a file which provides a counterpart device searching a DLNA device with information regarding the DLNA device, and may include a URL of a media file corresponding to the DLNA device.

The device information extracting unit 220 extracts URLs of media files corresponding to peripheral apparatuses and the model names of the peripheral apparatuses from device information searched by the device information search unit 210.

The media file may include at least one of an image file, a video file, and an audio file corresponding to the respective peripheral apparatuses.

The image file may include an image representing the respective peripheral apparatus. The video file and the audio file may be files regarding detailed description of how to use the respective peripheral apparatuses.

In other words, the device information extracting unit 220 extracts not only model names of peripheral apparatuses as detailed information of the peripheral apparatuses but also image files of the peripheral apparatuses and video files and audio files regarding how to use the peripheral apparatuses.

If there is no URL of a media file corresponding to the respective peripheral apparatuses, the model name transmitting unit 230 transmits model names of the peripheral apparatuses to a specified web server 100 and receives media files corresponding to the peripheral apparatuses from the specified web server 100.

In another exemplary embodiment, the device description XML files provided from the peripheral apparatuses may include a media file corresponding to the respective peripheral apparatuses. In the case that there is no media file included in the device description XML file, the model name transmitting unit 230 may transmit model names of peripheral apparatuses to a specified web server 100.

In other words, if a media file corresponding to a respective peripheral apparatus is not included in the device description XML file provided from the peripheral apparatus, a model name of the peripheral apparatus may be transmitted to a specified web server so that a media file corresponding to the model of the peripheral apparatus may be received.

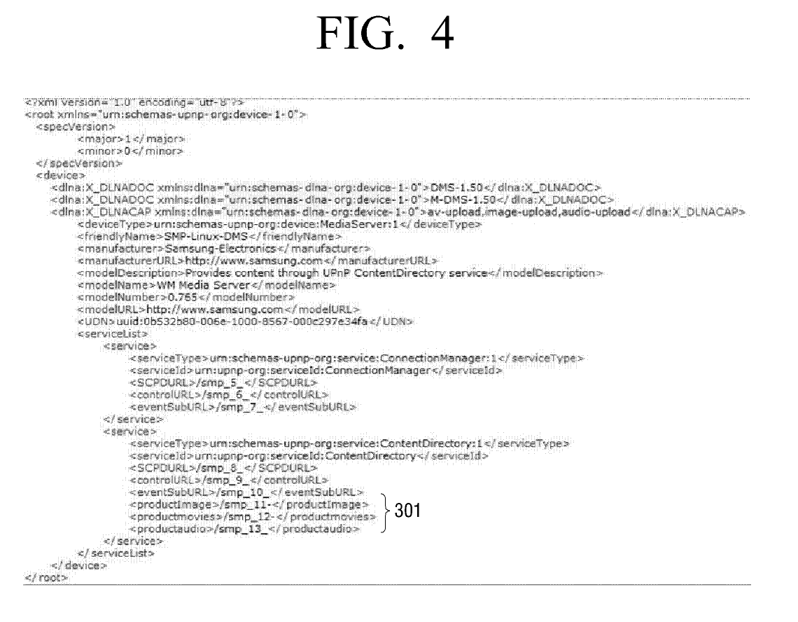

FIG. 4 is a view illustrating an example of a device description XML file as device information of a ULNA device display apparatus according to an exemplary embodiment of the present general inventive concept.

As illustrated in FIG. 4, a device description XML file includes a media file 301 corresponding to a peripheral apparatus. Albeit not illustrated in FIG. 4, the device description XML file may include a URL of a media file corresponding to the peripheral apparatus.

Referring back to FIG. 3, if there is a URL of a media file corresponding to a respective peripheral apparatus, the media file receiving unit 240 receives the media file corresponding to the respective peripheral apparatus from the URL.

According to an exemplary embodiment, if there is no URL of a media file corresponding to a respective peripheral apparatus, the model name transmitting unit 230 may transmit a model name of the respective peripheral apparatus to a specified web server 100 and a media file corresponding to a model name of the respective peripheral apparatus may be received from the specified web server 100.

According to another exemplary embodiment, the device description XML files provided from the peripheral apparatuses may include a media file corresponding to the respective peripheral apparatuses. In the case that there is no media file in the device description XML file of a respective peripheral apparatus, the model name transmitting unit 230 may transmit model names of peripheral apparatuses to a specified web server 100 and receive the media file corresponding to the respective peripheral apparatus from the specified web server 100.

The media file receiving unit 240 may receive a media file using a HTTP protocol.

The storage unit 250 stores the received media file.

In other words, the media file receiving unit 240 receives a media file using a HTTP protocol, stores the corresponding media file in a storage unit, and provides the stored media file as detailed information of a device whenever the corresponding device is searched.

The display unit 260 outputs a user interface (UI) for the media files corresponding to the peripheral apparatuses and model names of the peripheral apparatuses.

In other words, not only a friendly name of at least one searched DLNA device but also UIs for an image file, a video file and an audio file may be output and displayed.

As described above, a DLNA device display apparatus according to an exemplary embodiment outputs not only the name of a device but also UIs for an image, video, and music corresponding to the device when DLNA devices are searched, and thus a user may identify searched devices easily.

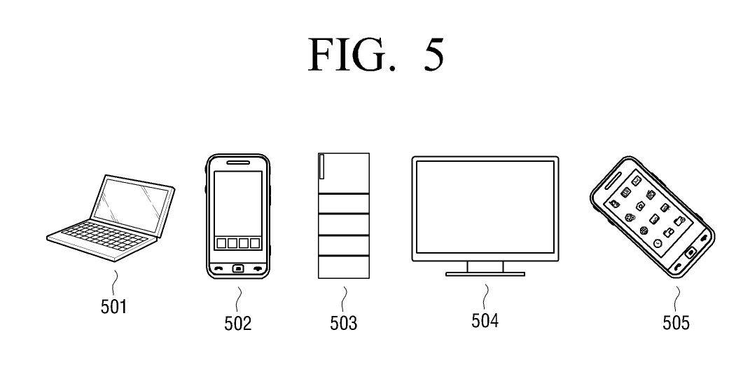

FIG. 5 is a view illustrating an example of an image of a searched device in a DLNA device display apparatus according to an exemplary embodiment of the present general inventive concept.

As illustrated in FIG. 5, an image of a searched device may be output and displayed to make it easier to identify searched devices.

For example, FIG. 5 illustrates an image corresponding to a notebook computer 501, an image corresponding to a first mobile phone 502, an image corresponding to a desktop computer 503, and image corresponding to a television 504, and an image corresponding to a second mobile phone 505.

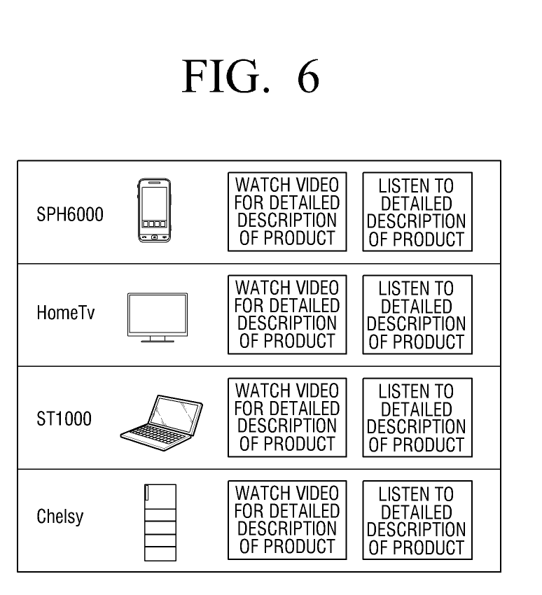

FIG. 6 is a view illustrating an example of a list UI to display searched devices in a DLNA device display apparatus according to an exemplary embodiment.

As illustrated in FIG. 6, the model name of a searched device is displayed along with UIs for an image corresponding to the searched device and for video and music for detailed description on how to use the searched device. For example, the first row of the list includes the model name “SPH6000”, an image corresponding to a mobile phone type device, and UIs to access a video file of a detailed description of the product and an audio file of a detailed description of the product.

Hereinafter, description regarding the DLNA display apparatus which is overlapped with the above description will be explained briefly.

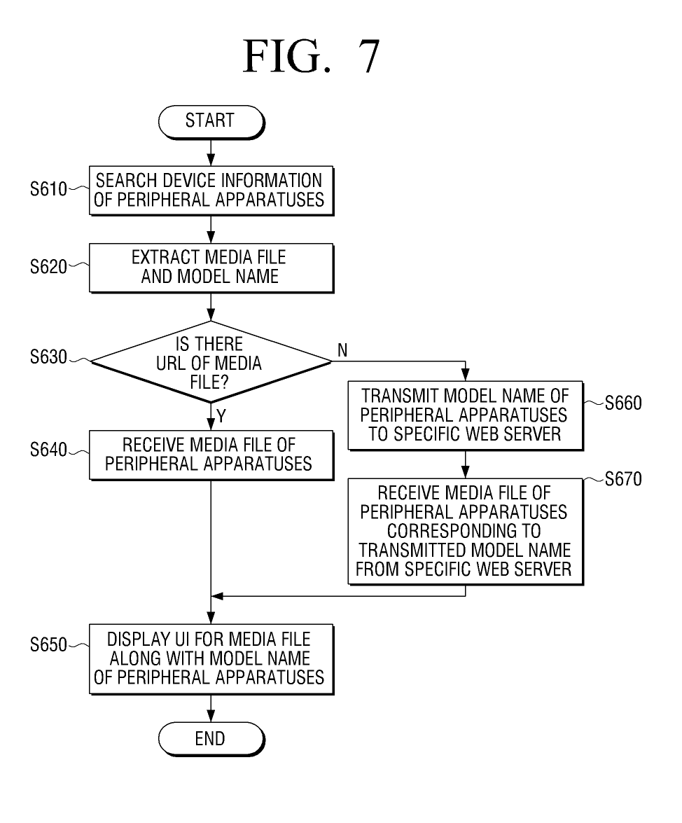

FIG. 7 is a flowchart illustrating a method of displaying a DLNA device according to an exemplary embodiment of the present general inventive concept.

First of all, device information of peripheral apparatuses is searched in operation S610.

The device information may be a device description XML file.

In addition, device information of peripheral apparatuses may be searched using an UPnP SSDP protocol in the operation of searching device information of peripheral apparatuses (operation S610).

Subsequently, a URL of a media file corresponding to a respective peripheral apparatus and a model name of a respective peripheral apparatus is extracted from the searched device information in operation S620.

The media file may include at least one of an image file, a video file, and an audio file corresponding to a respective peripheral apparatus.

In addition, the video file and the audio file may be files regarding detailed description on how to use the respective peripheral apparatus.

Subsequently, it is determined whether there is a URL of a media file corresponding to the respective peripheral apparatus in operation S630.

If it is determined that there is a URL of a media file corresponding to the respective peripheral apparatus, a media file corresponding to the respective peripheral apparatus is received from the URL in operation S640.

A media file may be received using a HTTP protocol in the operation of receiving a media file (operation S640).

According to an exemplary embodiment of the present general inventive concept, the operation of storing a received media file may be included after a media file is received in operation S640.

According to an exemplary embodiment of the present general inventive concept, if there is no URL of a media file corresponding to a respective peripheral apparatus in operation S630, model names of peripheral apparatuses are transmitted to a specified web server in operation S660 and a media file corresponding to the model name of the respective peripheral apparatus is received from a specified web server in operation S670.

According to another exemplary embodiment of the present general inventive concept, the device information may include a media file corresponding to a peripheral apparatus. According to the exemplary embodiment, if there is no media file in device information searched in operation S630, model names of peripheral apparatuses may be transmitted to a specified web server and a media file corresponding to the model name of the respective peripheral apparatus may be received from the specified web server.

Lastly, a UI to access the media files corresponding to the peripheral apparatuses is displayed along with model names of peripheral apparatuses in operation S650.

Therefore, a DLNA device display apparatus according to an exemplary embodiment outputs not only the model name of a searched device but also UIs for an image, video, and audio regarding the searched device when DLNA devices are searched, and thus a user may identify searched devices easily.

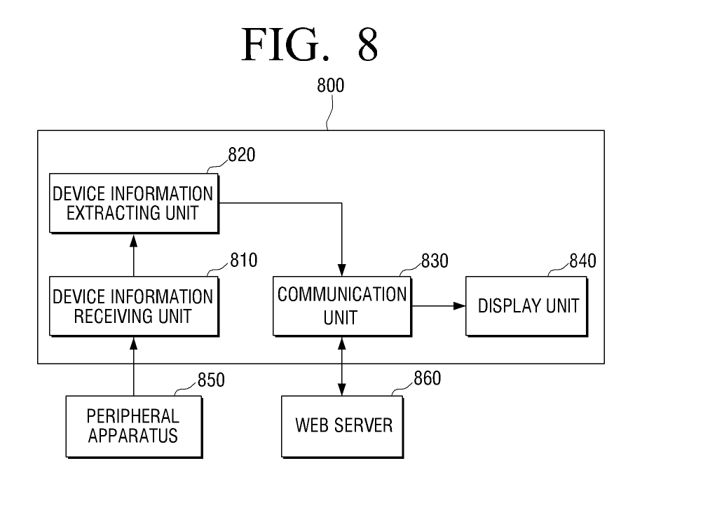

FIG. 8 illustrates a DLNA device display apparatus 800 according to an exemplary embodiment of the present general inventive concept. The DLNA device display apparatus 800 illustrated in FIG. 8 comprises a device information receiving unit 810, a device information extracting unit 820, a communication unit 830, and a display unit 840. The DLNA device display apparatus 800 is connected to at least one peripheral apparatus 850 and a specified web server 860. The peripheral apparatus may be a DLNA compliant device.

The device information receiving unit 810 receives device information from the peripheral apparatus 850. The device information may include a model name of the peripheral apparatus 850 and a URL of a media file corresponding to the peripheral apparatus 850.

The device information extracting unit 820 determines whether the device information includes a URL of a media file corresponding to the peripheral apparatus 850. The device information extracting unit 820 may extract the model name of the peripheral apparatus 850 and the URL of the media file corresponding to the peripheral apparatus 850 from the device information.

The communication unit 830 retrieves the media file corresponding to the peripheral apparatus 850 from the URL if the URL is included in the device information. If the URL is not included in the device information, the communication unit 830 transmits the model name to the specified web server 860 and receives a media file corresponding to the model name of the peripheral apparatus 850 from the specified web server 860.

The media file may include at least one of an image file including an image representing the peripheral apparatus, a video file including a video about the peripheral apparatus, and an audio file including audio information about the peripheral apparatus.

The display unit 840 displays a UI including the model name of the peripheral apparatus 850, the image representing the peripheral apparatus, and menu items to access the video and audio information about the peripheral apparatus 850. If there is more than one peripheral apparatus 850 connected to the DLNA display apparatus 800, the display unit 840 displays a list including the model name of each connected peripheral apparatus 850, images representing each connected peripheral apparatus 850, and menu items to access the video and audio information about each connected peripheral apparatus 850.

Exemplary embodiments of present general inventive concept may be embodied as a program command which can be executed through various computer means and recorded in a recording medium readable by a computer. In this case, the recording medium readable by a computer may include a program command, a data file, and data structure, alone or in combination. Meanwhile, the program command recorded in a recording medium may be designed and configured specially for the present invention, or may be known to and used by those skilled in the computer software industry.

The recording medium readable by a computer includes magnetic media such as a hard disk, a floppy disk, and a magnetic tape, optical media such as a CD-ROM and a DVD, magneto-optical media such as a floptical disk, and a hardware apparatus specially designed to store and perform a program command such as ROM, RAM, and a flash memory. Meanwhile, such a recording medium may be a transmission medium such as an optical or metal strip and waveguide including carrier wave which transmits a signal designating a program command, data configuration, and so forth.

In addition, the program command includes a machine code composed by a compiler and a high-level language code executable by a computer using an interpreter. The above-described hardware apparatus may be configured to operate as more than one software module to perform operations of the present invention and vice versa.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of displaying at least one device connected through a DLNA way in a DLNA device, the method comprising:
searching device information of one or more peripheral apparatuses;
extracting URLs of media files corresponding to the one or more peripheral apparatuses respectively from the searched device information;
if there is a URL of a media file corresponding to a respective peripheral apparatus, receiving the media file corresponding to the respective peripheral apparatus from the URL; and
displaying a UI to access the media files corresponding to the one or more peripheral apparatuses along with model names of the one or more peripheral apparatuses.

2. The method according to claim 1, comprising:
if there is no URL of the media file corresponding to the respective peripheral apparatus, transmitting the model name of the respective peripheral apparatus to a specified web server; and
receiving a media file corresponding to the model name of the respective peripheral apparatus from the specified web server.

3. The method according to claim 1, comprising:
if the media file corresponding to the respective peripheral apparatus is not included in the searched device information, transmitting the model name of the respective peripheral apparatus to a specified web server; and
receiving a media file corresponding to the model name of the respective peripheral apparatus from the specified web server.

4. The method according to claim 1, wherein the device information is a device description XML file.

5. The method according to claim 1, wherein the media file corresponding to the respective peripheral apparatus includes at least one of an image file, a video file, and an audio file corresponding to the respective peripheral apparatus.

6. The method according to claim 5, wherein the video file and the audio file are files including a detailed description on how to use the respective peripheral apparatus.

7. The method according to claim 1, wherein the searching device information of the one or more peripheral apparatuses comprises searching device information of the one or more peripheral apparatuses using a UPnP SSDP protocol.

8. The method according to claim 1, wherein the receiving the media file corresponding to the respective peripheral apparatus comprises receiving the media file using a HTTP protocol.

9. The method according to claim 1, further comprising:
storing the received media file.

10. A DLNA device display apparatus to display at least one device connected through a DLNA way, the apparatus comprising:
a device information search unit to search device information of one or more peripheral apparatuses;
a device information extracting unit to extract URLs of media files corresponding to the one or more peripheral apparatuses and model names of the one or more peripheral apparatuses respectively;
a media file receiving unit which, if there is a URL of a media file corresponding to a respective peripheral apparatus, receives the media file corresponding to the respective peripheral apparatus from the URL; and
a display unit to display a UI to access the media files corresponding to the one or more peripheral apparatuses along with model names of the one or more peripheral apparatuses.

11. The apparatus according to claim 10, further comprising:
a model name transmitting unit which, if there is no URL of the media file corresponding to the respective peripheral apparatus, transmits the model name of the respective peripheral apparatus to a specified web server,
wherein the media file receiving unit receives a media file corresponding to the model name of the respective peripheral apparatus from the specified web server.

12. The apparatus according to claim 11, wherein the model name transmitting unit transmits the model name of the respective peripheral apparatus to a specified web server if the media file corresponding to the respective peripheral apparatus is not included in the searched device information,
wherein the media file receiving unit receives a media file corresponding to the model name of the respective peripheral apparatus from the specified web server.

13. The apparatus according to claim 10, wherein the device information is a device description XML file.

14. The apparatus according to claim 10, wherein the media file corresponding to the respective peripheral apparatus includes at least one of an image file, a video file, and an audio file corresponding to the respective peripheral apparatus.

15. The apparatus according to claim 14, wherein the video file and the audio file are files including a detailed description on how to use the respective peripheral apparatus.

16. The apparatus according to claim 10, wherein the device information search unit searches device information of the one or more peripheral apparatuses using a UPnP SSDP protocol.

17. The apparatus according to claim 10, wherein the media file receiving unit receives the media file corresponding to the respective peripheral apparatus using a HTTP protocol.

18. The apparatus according to claim 10, further comprising:
a storage unit to store the received media file.
